(19) United States
(12) Patent Application Publication
(10) Pub. No.: US 2009/0268251 A1
(43) Pub. Date: Oct. 29, 2009

(54) IMAGE PROCESSING APPARATUS, IMAGE PROCESSING METHOD AND COMPUTER-READABLE MEDIUM

(75) Inventor: Yasushi NISHIDE, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/323,752

(22) Filed: Nov. 26, 2008

(30) Foreign Application Priority Data
Apr. 28, 2008 (JP) 2008-117170

(51) Int. Cl. G06K 15/02

(52) U.S. Cl. 358/2.1

(57) ABSTRACT

An image processing apparatus includes a color transformation unit and an image processing unit. The color transformation unit color-transforms pixel values of respective pixels expressed by input image information from values in a color space of the input image information into values in a color space of a printer to generate images of respective color plates in the color space of the printer, and generates a control image in which each pixel has a pixel value indicating a type of an image object to which each pixel belongs. The image processing unit applies image processing to each pixel in the image of each color plate in accordance with the type of the image object indicated by the pixel value of a pixel, corresponding to each pixel in the image of each color plate, of the control image and feeds the processed images of the respective color plates to the printer.

### CROSS-REFERENCE TO RELATED APPLICATIONS

This application is based on and claims priority under 35 USC 119 from Japanese Patent Application No. 2008-117170 filed Apr. 28, 2008.

### BACKGROUND

1. Technical Field

The invention relates to an image processing apparatus, an image processing method, a computer-readable medium storing an image processing program and a computer data signal.

2. Related Art

In order to attain improvement in image quality of each image object at the printing output time, there has been proposed a print output control of switching image processing in accordance with a type of each image object such as character or photograph to thereby perform image processing optimized for each image object.

### SUMMARY

According to an aspect of the invention, an image processing apparatus includes a color transformation unit and an image processing unit. The color transformation unit color-transforms pixel values of respective pixels expressed by input image information from values in a color space of the input image information into values in a color space of a printer to generate images of respective color plates in the color space of the printer, and generates a control image in which each pixel has a pixel value indicating a type of an image object to which each pixel belongs. The image processing unit applies image processing to each pixel in the image of each color plate in accordance with the type of the image object indicated by the pixel value of a pixel, corresponding to each pixel in the image of each color plate, of the control image and feeds the processed images of the respective color plates to the printer.

### BRIEF DESCRIPTION OF THE DRAWINGS

Exemplary embodiments of the invention will be described in detail based on the following figures, wherein.

FIG. 1 is a diagram showing an example of the configuration of a system according to an exemplary embodiment of the invention;

FIG. 2 is a view for explaining the function of a CMM;

FIG. 3 is a view showing an example of PDL description containing designation of a spot color.

FIG. 4 is a view showing another example of PDL description containing designation of a spot color;

FIG. 5 is a flow chart showing an example of a process procedure in the CMM for generating a tag plate indicating pixels of a spot color;

FIG. 6 is a flow chart showing an example of a process procedure for controlling application of an LUT using the tag plate indicating the pixels of the spot color;

FIG. 7 is a flow chart showing an example of a process procedure in the CMM for generating a tag plate indicating pixels of K100;

FIG. 8 is a flow chart showing an example of a process procedure for performing a K100 high resolution output using the tag plate indicating pixels of K100;

FIG. 9 is a flow chart showing an example of a process procedure in the CMM for generating a tag plate discriminating between “photograph” and “character”;

FIG. 10 is a diagram for explaining screen process control using the tag plate discriminating between “photograph” and “character”;

FIG. 11 is a diagram showing the configuration of a system according to a modification example of the exemplary embodiment;

FIG. 12 is a flow chart showing an example of a process procedure in the CMM in the modification example; and

FIG. 13 is a diagram showing an example of the hardware configuration of a computer.

### DETAILED DESCRIPTION

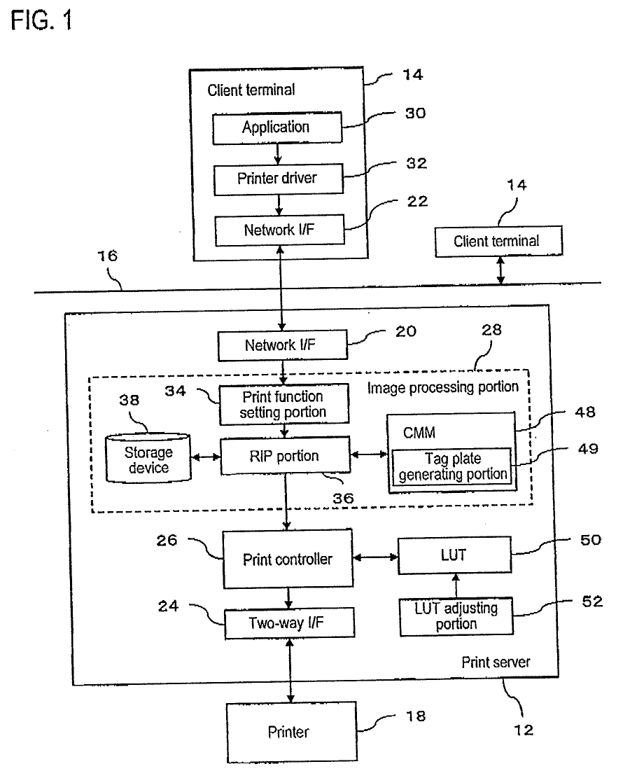

The schematic configuration of a system according to an exemplary embodiment of the invention will be described first with reference to FIG. 1. This system includes a print server 12, at least one client terminal 14, and a network 16 such as an LAN (local area network) through which the print server 12 and the client terminal 14 are connected to each other. The print server 12 is an applied example of an image processing apparatus according to the invention. Although the following description will be made on the case where the image processing apparatus according to the invention is implemented as the print server 12, the image processing apparatus according to the invention is not limited thereto but may be implemented as any type intermediate server such as a file server connected to the client terminal 14 through the network 16.

A printer 18 for printing an image on a sheet is connected to the print server 12. The printing method used in the printer 18 is not particularly limited but may be an electrophotographic method or an ink jet printing method or may be another printing method. When the print server 12 receives a print job output from the client terminal 14, the print server 12 executes print output in accordance with the print job.

The print server 12 and the client terminal 14 have network interfaces (network I/Fs) 20 and 22 respectively. The print server 12 and the client terminal 14 are connected to the network 16 through the network I/Fs 20 and 22 respectively. The print server 12 further has a two-way interface (two-way I/F) 24. The print server 12 is connected to the printer 18 through the two-way I/F 24. Incidentally, the number of printers 18 and the number of two-way I/Fs 24 are not limited. For example, a plurality of printers 18 may be connected to the print server 12. For example, a plurality of two-way I/Fs 24 or a plurality of types of two-way I/Fs 24 may be used in the print server 12.

Such a print server 12 can be configured, for example, by a method of adding a control board having a predetermined function to a personal computer (PC). The print server 12 may have an input device such as a keyboard or a mouse, and a display device such as an LCD display.

The print server 12 has a print controller 26 for controlling the printer 18, and an image processing portion 28. When a print job written in PDL (page description language) is input from the client terminal 14 to the print server 12, the image processing portion 28 generates raster image data that the printer 18 can handle, based on the print job. The process of generating raster image data based on the print job is a process well-known as RIP (Raster Image Processing).

Incidentally, the print server 12 may perform job queue management of storing input print jobs into a job queue and successively reading the print jobs stored in the job queue to execute image processing such as RIP. Or the print server 12 may perform print queue management of storing raster data obtained by RIP or the like into a print queue and successively outputting the raster data from the print queue to the printer 18. Or the print server 12 may perform hold queue management of storing undesignated print jobs and inexecutable print jobs into a hold queue to hold these print jobs. There queue managements are commonly known in the related art and will not be described any more in this specification.

On the other hand, the client terminal 14 has various types of applications 30. The client terminal 14 performs image processing and document processing such as document and image creating, processing, editing, etc. using the applications 30.

The client terminal 14 further has a printer driver 32. The printer driver 32 transforms the documents/images generated by the applications into data written in PDL or the like and transmits a print job as a result of the transformation to the print server 12. The print server 12 applies designated image processing to the print job and outputs the processed print job to the printer 18. As a result, printed matter corresponding to the print job is obtained.

The image processing portion 28 of the print server 12 has a print function setting portion 34. Upon reception of a print job, the print function setting portion 34 performs setting of various types of print functions designated by the printer driver 32 or the like and written in data of the print job. Incidentally, setting of various types of print functions commonly known in the related art can be made in the print server 12. The print function setting portion 34 determines and sets the print functions designated by the print job so that the respective print functions can be executed.

The image processing portion 28 further has an RIP portion 36. The RIP portion 36 executes RIP processing on the print job input from the client terminal 14. That is, the RIP portion 36 interprets PDL descriptions of the print job to thereby generate raster image data expressed by the PDL descriptions. The RIP processing is performed based on the print functions set by the print function setting portion 34. By the processing in the RIP portion 36, raster image data of respective process color plates of C (cyan), M (magenta), Y (yellow) and K (black) are generated for each of pages of the print job.

On this occasion, the RIP portion 36 controls a CMM (Color Management Module or Color Matching Module) 48 to perform color transformation when the RIP processing is executed.

The CMM 48 transforms a color of an image for a certain device (i.e. a combination of values of respective color components in a color space of the device) so that a color as close to the original color as possible is reproduced in another device. More specifically, the CMM 48 transforms a color in a color space of the print job into a color in a color space of the printer 18 which is an output device. This transformation is called “color transformation”, “color space transformation”, etc. The CMM 48 executes such color transformation, for example, using a color profile (called “ICC profile”) compliant with the Standard provided by ICC (International Color Consortium). Because the CMM 48's color transformation using the color profile can be achieved by a commonly known processing method, the detailed description thereof will be omitted here.

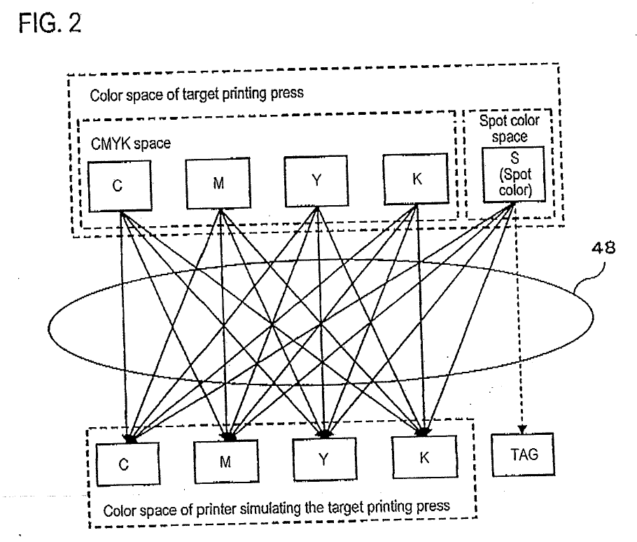

The color transformation in the CMM 48 is performed, for example, for print simulation. That is, print simulation is performed so that when a print job for a certain printing press (referred to as target printing press) is to be printed by the printer 18, the printer 18 can perform printing with color reproduction characteristic as close to the color reproduction characteristic of the target printing press as possible. In this case, the color space of the print job is a color space of the target printing press. Even when both the color space of the target printing press and the color space of the printer 18 simulating it are CMYK spaces, the two color spaces are different in color characteristic. In the print simulation, it is therefore necessary to transform CMYK values for the target printing press into CMYK values for the printer 18 as shown in FIG. 2. When the target printing press can use ink of a special color (referred to as “spot color” or “custom color”) other than process colors (i.e. CMYK) while the printer 18 cannot use any special color other than process colors, it is further necessary to map colors in the color space of the target printing press, inclusive of the spot color S added to CMYK, onto the CMYK color space of the printer 18. The CMM 48 executes a color transformation process, for example, for such print simulation. Incidentally, the print simulation is only an example of an intended use of the CMM 48. For example, the CMM 48 may be used for general color matching between different devices, such as color matching between a color display device such as a liquid crystal display and the printer 18.

In this exemplary embodiment, this function of the CMM 48 is used for generating a tag plate. The tag plate has raster image data different from those of the CMYK color plates. The tag plate is used for controlling image processing provided in the subsequent stage. In the apparatus disclosed in JP 2005-243003 A (corresponding to US 2005/0243374 A), a tag plate is generated by RIP processing after replacement of part of drawing commands in the print job. On the contrary, in this exemplary embodiment, the RIP portion 36 processes the original print job data without replacement of such drawing commands. In the RIP processing, the RIP portion 36 calls the CMM 48 for color transformation. On this occasion, the CMM 48 generates the tag plate while performing ordinary color transformation using information acquired from the RIP portion 36.

When, for example, use of the spot color is designated in the print job, the RIP portion 36 designates the color space of the spot color and instructs the CMM 48 to perform color transformation from the color space of the spot color to the CMYK space of the printer 18. In response to the command, the CMM 48 generates a tag plate to distinguish between pixels corresponding to image objects to be drawn with the spot color and the other pixels. In FIG. 1, the CMM 48's function of generating the tag plate is shown as a tag plate generating portion 49. The tag plate can be used when different image processings are applied to pixels of the spot color and the other pixels respectively (details will be described later).

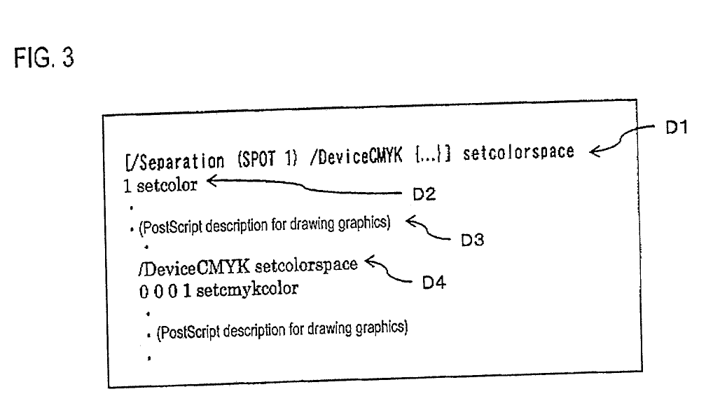

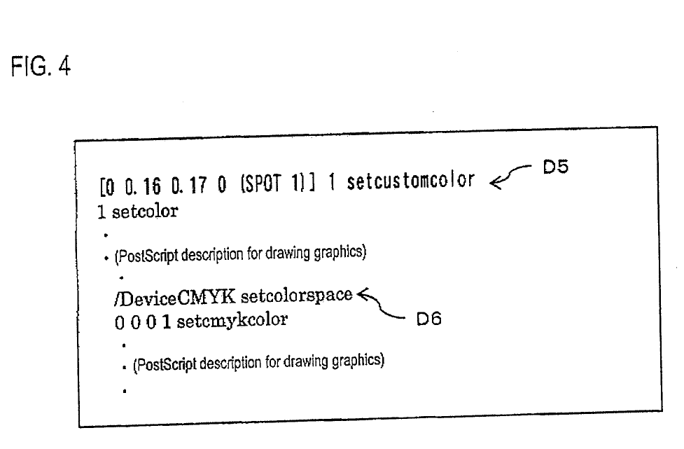

FIGS. 3 and 4 show an example of PDL description including designation of a spot color. The example is an example of use of PostScript (registered trademark) as a PDL. For example, the command D1 on line 1 in FIG. 3 is a command to set the current color space of the RIP portion 36 to a color space of the spot color identified by the name “SPOT 1”. The command D2 on line 2 is a command to set the current color to a color in which the density of only one color component of the current color space “SPOT 1” is 100%. Then, each of image objects designated by command lines D3 between the command D2 and a command D4 for the next color space is drawn with the spot color “SPOT 1”. The command D4 is a command to set the current color space to device CMYK. Then, image objects designated by command lines between the command D4 and a command for designating the color space of a next spot color are reproduced with colors in the device CMYK color space.

FIG. 4 shows another command D5 for designating a spot color. Each of image objects designated by command lines between the command D5 and a command D6 for designating the next color space is drawn with the spot color.

Incidentally, the image objects are individual drawing object images such as characters, photographs, lines, graphical figures (solid color figures), and gradation figures. A one-page's image contains at least one image object. Each image object is drawn in accordance with commands in PDL. For example, in the case of PostScript (registered trademark), a character object is designated by a “show” command, and a photograph object is designated by an “image” command. An image object to be drawn with a spot color can be specified based on a command designating a color space of the spot color as described above.

In an example in which a tag plate indicating pixels of a spot color is generated, as shown in FIG. 2, the CMM 48 transforms colors (CMYK and the spot color S) in the color space of the print job into colors in the CMYK space of the printer 18 and generates a tag plate TAG using information of the spot color S.

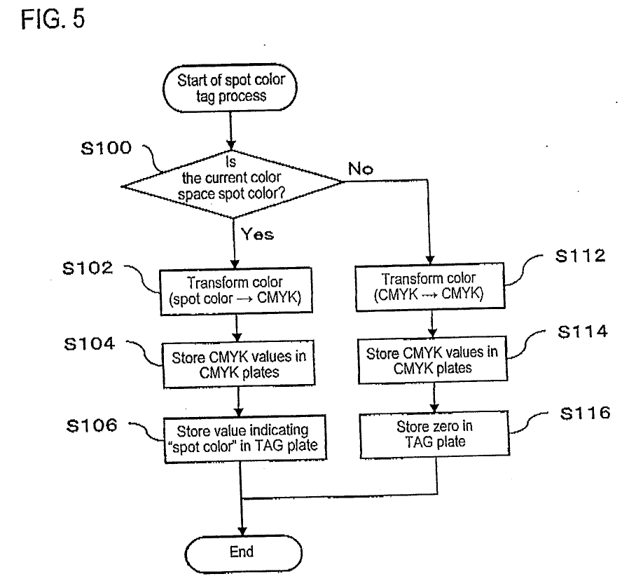

FIG. 5 shows an example of a process procedure in the CMM 48 in the case where a tag plate indicating pixels of a spot color is generated. This procedure is executed by the CMM 48 in accordance with calling from the RIP portion 36 when the RIP portion 36 intends to draw an image object in accordance with a command in PDL. At the time of the calling, the RIP portion 36 sends indices (coordinates) and values (CMYK values or values of the spot color S) of pixels constituting an image object to the CMM 48. The CMM 48 executes the procedure shown in Fig, 5 by using these pieces of information. The procedure shown in FIG. 5 can be applied to the case where the color space of the print job is composed of device CMYK colors and the spot color.

For the procedure shown in FIG. 5, the CMM 48 has a color space storage portion for storing the current color space. When a color space is designated from the RIP portion 36, identification information for identifying the designated color space is stored in the color space storage portion. When, for example, the RIP portion 36 interprets the command D1 shown in FIG. 3, the RIP portion 36 notifies the CMM 48 of the setting of the current color space to “SPOT 1”, and the CMM 48 stores “SPOT 1” in the color space storage portion in accordance with this notification. When, for example, the RIP portion 36 interprets the command D4 shown in FIG. 3, identification information indicating device CMYK is stored in the color space storage portion of the CMM 48, The processing of FIG. 5 for each image object is performed with reference to the current color space. Incidentally, when the RIP portion 36 calls the CMM 48 in accordance with each image object, the RIP portion 36 may notify the CMM 48 of the current color space instead of that the CMM 48 stores the color space.

In the procedure shown in FIG. 5, the CMM 48 first determines as to whether or not the current color space is a color space of the spot color (S100). When the current color space is a device color space such as device CMYK, the determination in the step S100 results in a negative answer (No).

When the current color space is a color space of the spot color (the determination in the step S100 results in a positive answer (Yes)), the CMM 48 performs color transformation from pixel values (values of the spot color) of pixels of an image object sent from the RIP portion 36 into pixel values in the CMYK space of the printer 18 (S102). A color profile for transformation of the values of the spot color into values in the CMYK space of the printer 18 is registered in the CMM 48 in advance. The CMM 48 writes the CMYK values of pixels obtained by the color transformation into corresponding pixels in the raster images of the respective CMYK color plates (i.e. stores the respective CMYK values in addresses corresponding to the pixels in a memory area for storing the respective color plates) (S104). The CMM 48 stores a value indicating “spot color” in corresponding pixels in the raster image of the tag plate (S106). The value indicating “spot color” is a value determined in advance. For simple discrimination between pixels of a spot color pixel and pixels of an ordinary color (e.g. CMYK), each pixel of the tag plate may have 1 bit. In this case, for example, the value of a pixel of a spot color is set to “1” while the value of a pixel of any other color is set to “0”. This is classification in the viewpoint as to whether or not the type of the image object is of the spot color. When image processing is controlled while attention is also paid to other types than the type as to whether or not it is a spot color, the number of bits constituting each pixel of the tag plate may be set to be not smaller than a required number capable of indicating the number of features to which attention is paid.

A lot of ink jet printers etc. use ink of another color in addition to four colors of CMYK. A lot of CMMs can generate multi-color plates of 5 colors or more to support these printers. In such CMMs, a plate of another color than CMYK can be allocated to a tag plate. In this case, the number of bits in each pixel of the tag plate is equal to the number of bits in process colors. For example, if the number of bits in each pixel of the tag plate is 8, the pixel can express 256 values at maximum. Of the 256 values, a value corresponding to the spot color may be determined in advance. In the following example, “0” is allocated as a pixel value of the tag plate to the type of an image object to be not specially handled in image processing whereas pixel values other than “0” are allocated to the types of image objects to be specially handled, respectively. Incidentally, this is only one instance.

Alternatively, for example, respective bits of each pixel of the tag plate may be allocated to different types of image objects, respectively so that one pixel can express that it corresponds to plural types. When, for example, the most significant bit is allocated to determination as to whether or not it is a spot color and when the second bit is allocated to determination as to whether or not it is a character, it can be found that a pixel having the most significant bit and the second bit of both “1” is a pixel of a spot color belonging to a character object.

When the current color space is not a spot color space, that is, when the current color space is a device CMYK space, the CMM 48 performs color transformation from CMYK values of respective pixels of the image object sent from the RIP portion 36 into pixel values in the CMYK space of the printer 18, respectively (S112). Then, the CMM 48 writes the CMYK values of respective pixels obtained by the color transformation into corresponding pixels in the raster images of the CMYK color plates, respectively, (S114) and writes “0” into corresponding pixels in the raster image of the tag plate (S116).

In the tag plate generated by the aforementioned process procedure, each of pixels of an image object to be drawn with the spot color has a value indicating “spot color” while each of pixels of an image object to be drawn with any other color (i.e. a color in an ordinary color space such as a CMYK space in the print job) than the spot color has a value “0”.

Referring to FIG. 1 again, respective raster image data of the CMYK plates generated thus by cooperation of the CMM 48 and the RIP portion 36 are fed to the printer 18 through the print controller 26 and the two-way I/F 24.

On this occasion, the print controller 26 or the printer 18 may perform image processing on the respective raster image data of the CMYK plates. For example, the case where image tone adjustment is performed with reference to an LUT (look-up table) 50 is shown as an example of such image processing in FIG. 1. The LUT 50 is a table which expresses a curve indicating tone reproduction characteristic (called TRC (Tone Reproduction Curve)) in accordance with each process color (e.g. CMYK), of a print engine provided in the printer 18. Correspondence between pixel values of an input image and output pixel values corresponding to the input pixel values is registered in the LUT 50, e.g. in accordance with each process color. The print controller 26 transforms values of pixels of raster images of the respective CMYK plates input from the RIP portion 36 by referring to the LUT 50. The tone adjustment using the LUT 50 has been heretofore performed for purposes such as correction of characteristic change of the print engine with the passage of time after use and delicate tone adjustment unabsorbable to the CMM. For example, a user corrects the TRC of the LUT 50 by glancing through a test sleet output from the printer 18 and operating an LUT adjusting portion 52 to achieve desired tone reproduction. Because such tone adjustment using the LUT 50 is a commonly known technique, the tone adjustment will not be described any more.

In this exemplary embodiment, as an example of image processing control using a tag plate, tone adjustment using the LUT 50 is controlled in accordance with the tag plate. That is, tone adjustment is controlled in accordance with whether or not each pixel value of the tag plate generated in the process procedure of FIG. 5 by the CMM 48 indicates “spot color”.

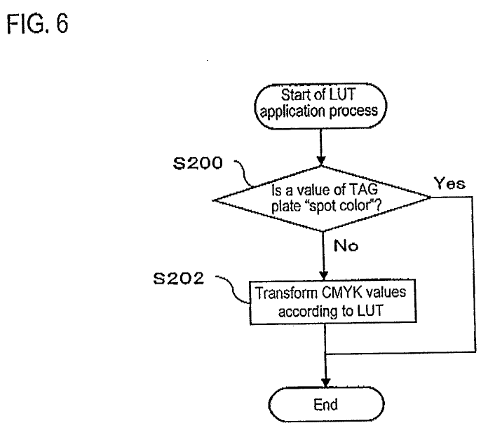

As an example, in a procedure shown in FIG. 6, the print controller 26 makes a determination, in accordance with each of pixels of the CMYK plates input from the RIP portion 36, as to whether or not the value of a corresponding pixel in the tag plate indicates “spot color” (S200). When this determination results in that the corresponding pixel does not indicate “spot color”, the print controller 26 transforms the values of corresponding pixels of the CMYK plates respectively by referring to the LUT 50 (S202). On the other hand, when this determination results in that the corresponding pixel indicates “spot color”, the print controller 26 skips over the pixel value transformation using the LUT 50.

According to the aforementioned process, tone adjustment using the LUT 50 is not applied to spot color objects. For example, a spot color is often used for a corporate color emblematizing an enterprise or organization. In most cases, print simulation gives importance to reproduction of such a spot color. Accordingly, a work procedure of adjusting reproduction of ordinary colors finely by changing the LUT 50 may be used on the job site after a profile is adjusted on the spot color so that the spot color can be reproduced accurately. The spot color is expressed in combination with the ordinary colors such as CMYK in the print simulation. Accordingly, if the LUT 50 is changed after spot color reproduction characteristic is held, the spot color reproduction characteristic which has been preciously held is spoiled. Therefore, when processing is performed in the same manner as in the aforementioned exemplary embodiment so that the LUT 50 is not applied to pixels of the spot color, the spot color reproduction characteristic can be held.

The raster image data of the CMYK plates subjected to selective LUT processing by the print controller 26 as described above are fed to the printer 18 through the two-way I/F 24. The printer 18 performs image formation by superposing the raster images of the respective color plates on a recording medium such as a sheet of paper to thereby generate full color printed matter.

An example has been described above. In the example, image processing on the raster images is controlled based on classification as to whether or not each image object is an image object to be drawn with “spot color”.

Next, control based on classification as to whether or not each image object is an image object to be drawn with “K100”, will be described as a second example.

“K100” is so-called “solid black” which is a color with a density represented by 100% K, 0% C, 0% M and 0% Y in a CMYK space. For example, in order to express characters and line drawings finely, some recent print engine has a function of printing an image object whose color is expressed by K100 with a higher resolution than those for other C, M and Y plates. For example, this function is achieved by processing in which high resolution raster images are generated by the RIP so that the raster image of a K100 object without change of the resolution thereof is fed to the printer 18, but the raster images of other objects than the K100 object are fed to the printer 18 after the resolutions thereof are lowered (incidentally, this is only an instance). Such a function is hereinafter referred to as “K100 resolution heightening function”. Because texts and line drawings for designs are often expressed by K100, fine printing of these contributes greatly to improvement of print quality.

Therefore, in the second example, information as to whether or not each image object is an image object drawn with “K100”, is given to a tag plate so that on/off control of the K100 resolution heightening function in the printer 18 is performed based on the tag plate.

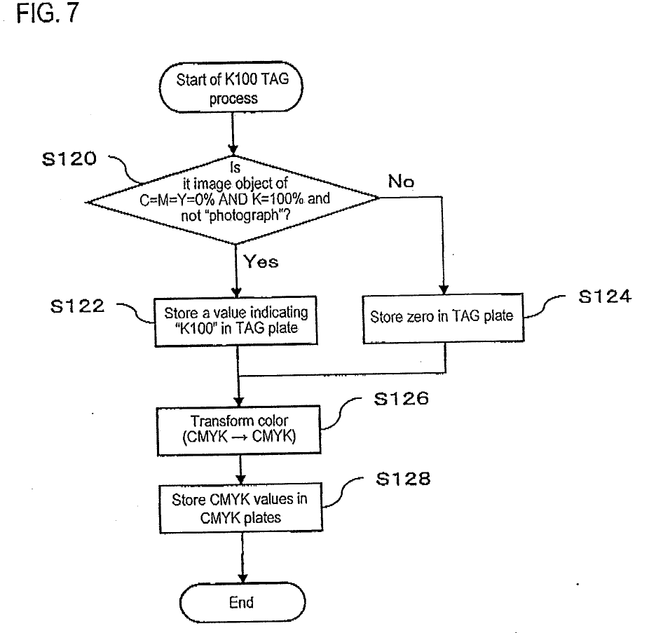

FIG. 7 shows an example of a process procedure executed by the CMM 48 in the second example. In this procedure, the CMM 48 first determines as to whether or not the image object whose color transformation is requested by the RIP portion 36 is an image object of C=M=Y=0% and K=100% and is not “photograph” (S120). In this example, “photograph” is removed from subjects of the K100 resolution heightening function because the K100 resolution heightening function has little effect on “photograph”.

In the determination in the step S120, whether or not it is C=M=Y=0% and K=100% can be determined, for example, based on the pixel value which is fed as a subject of the color transformation to the CMM 48 by the RIP portion 36.

Since the RIP portion 36 can determine from PDL description of the print job whether or not the image object expressed by the description is a photograph, the RIP portion 36 may notify the CMM 48 of this information. For example, in PostScript, the RIP portion 36 can determine as to whether or not the image object is “photograph”, based on whether or not the command is “image”, because a photograph is indicated by a command “image”. Incidentally, some existing RIP system has an interface which outputs information indicating the type of the image object among “character” type, “line” type, “graphical figure” type (“solid” type), “gradation image” type, “photograph” type, etc. When this kind of RIP system is used as the RIP portion 36, the CMM 48 can determine as to whether or not the image object is “photograph”, based on the object type information provided from the RIP portion 36. Although description has been made on the case where whether or not the image object is “photograph” is determined in order to simplify description, whether or not the image object is a photograph-like continuous tone image (such as a character or a line drawing) may be determined practically. This determination may be made also based on a drawing command in PDL.

When the determination in the step S120 results in a positive answer (Yes), the CMM 48 writes a value indicating “K100” into each of pixels corresponding to the image object in the tag plate (S122). On the other hand, when the determination in the step S120 results in a negative answer (No), the CMM 48 writes “0” into each of pixels corresponding to the image object in the tag plate (S124). In either case, the CMM 48 transforms CMYK values of respective pixels of the object input from the RIP portion 36 in accordance with the profile (S126) and writes results of the color transformation into the CMYK plates respectively (S128).

According to the aforementioned process, CMYK plates fed to the printer 18, and a tag plate indicating whether or not each pixel belongs to an object of K100 are generated.

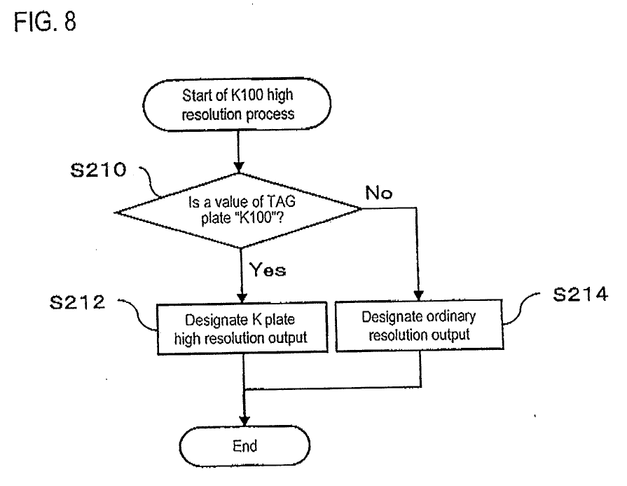

FIG. 8 shows an example of a process procedure in the print controller 26, which receives the CMYK plates and the tag plate. In this procedure, the print controller 26 determines, in accordance with each of pixels (which are pixels in the case where the resolution heightening function is not used) of the CMYK plates input from the RIP portion 36, whether or not the value of a corresponding pixel in the tag plate indicates “K100” (S210). When the determination results in that the pixel indicates “K100”, for example, the print controller 26 provides a high resolution image (i.e. one pixel expressed by a combination of finer pixels) of the K plate for that pixel to the printer 18 and instructs the printer 18 to output the K plate with a high resolution (S212). On the other hand, when the determination results in that the pixel does not indicate “K100”, the print controller 26 instructs the printer 18 to output the values of that pixel of the CMYK plates with an ordinary resolution (S214).

According to the aforementioned process, objects of K100 can be printed with a higher resolution than that of other objects.

The case of control of a halftone screen process applied to a raster image in accordance with whether the type of an image object is “photograph” or “character” will be described below as a third example.

In the halftone screen process, it is known that a relatively low screen frequency (decrease in the number of screen lines) is suitable for expressing a continuous tone image such as a photograph in smooth gradation whereas a relatively high screen frequency (increase in the number of screen lines) is suitable for improving reproducibility of a fine line such as a character or a line drawing. There has been heretofore used a method in which a screen with a small number of lines is applied to each “photograph” object in a onepage's image whereas a screen with a large number of lines is applied to each “character” object in the one-page's image. In the third example, the CMM 48 generates a tag plate for discriminating between “photograph” and “character”.

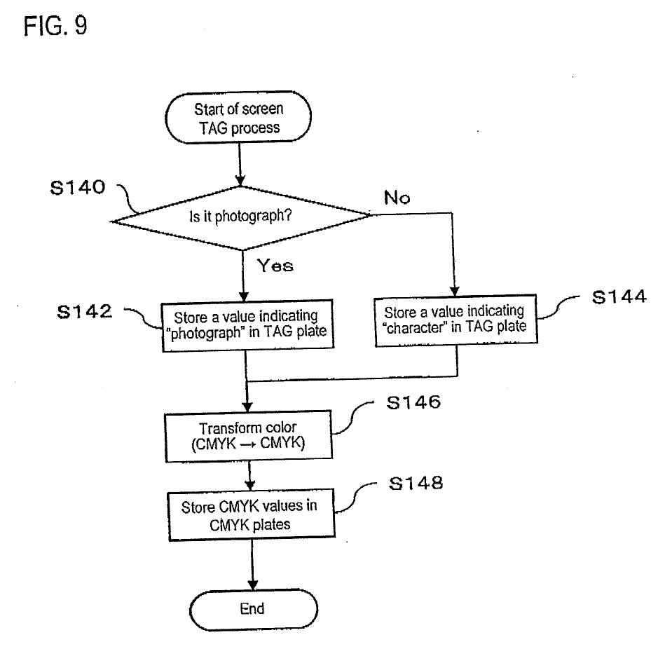

FIG. 9 shows an example of a process procedure in the CMM 48 according to the third example. In this procedure, the CMM 48 first determines as to whether or not the image object requested by the RIP portion 36 to be subjected to color transformation is “photograph” (in other words, “character” or not) (S140). For example, the RIP portion 36 may provide information indicating the type (such as character, line, graphical FIG. (solid color), gradation image, photograph, etc.) of the target image object to the CMM 48 so that the CMM 48 can make the determination of the step S140 based on this information. Alternatively, the user may set information as to whether the type is “photograph” or “character” into the CMM 48.

When the determination in the step S140 results in a positive answer (Yes), the CMM 48 writes a value indicating “photograph” into each pixel corresponding to the image object in the tag plate (S142). On the other hand, when the determination in the step S140 results in a negative answer (No), the CMM 48 writes a value indicating “character” into each pixel corresponding to the image object in the tag plate (S144). In either case, the CMM 48 transforms the CMYK values of each pixel of the object input from the RIP portion 36 in accordance with a profile (S146) and writes results of the transformation into the CMYK plates respectively (S148).

According to the aforementioned process, CMYK plates fed to the printer 18 and a tag plate indicating whether each pixel is “photograph” or “character” are generated.

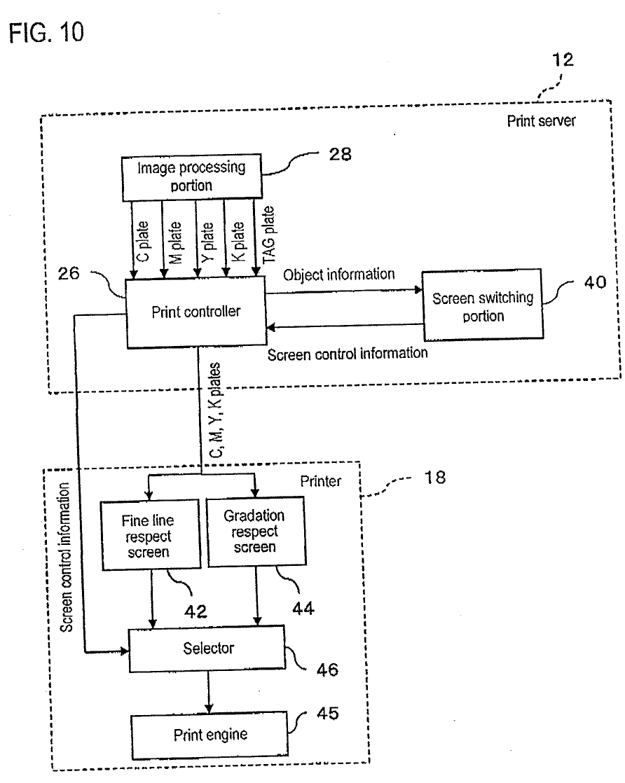

An example of screen control by the print controller 26, which receives the CMYK plates and the tag plate) will be described with reference to FIG. 10.

In this example, the print server 12 has a screen switching portion 40. The screen switching portion 40 generates screen control information for controlling screen process based on object information expressed by each pixel value in the tag plate (i.e. information indicating the type of the object to which each pixel belongs, and in this example, information for discriminating between “photograph” and “character”). For example, the screen control information is information for designating the type of a screen applied to the pixel. In the example shown in FIG. 10, the printer 18 has a fine line respect screen 42 with a large number of lines, and a gradation respect screen 44 with a small number of lines. The screen control information indicates which of the two screens is to be used. The screen switching portion 40 provides a screen control signal indicating selection of the gradation respect screen 44 to the print controller 26 when the pixel value in the tag plate indicates “photograph”, and provides a screen control signal indicating selection of the fine line respect screen 42 to the print controller 26 when the pixel value in the tag plate indicates “character”. Incidentally, this is only an instance. The configuration may be made so that a user can set correspondence between the pixel value in the tag plate and the screen to be used.

The print controller 26 provides respective raster images of the CMYK plates to the printer 18 and provides the screen control information obtained from the screen switching portion 40 to a selector 46 of the printer 18.

The printer 18 performs screen process on the input raster images of the CMYK plates with the fine line respect screen 42 and the gradation respect screen 44 respectively. Image signals as results of the screen process with the screens 42 and 44 are fed to the selector 46. The selector 46 selects one of the output image signals of the screens 42 and 44 based on the screen control information and feeds the selected image signal to a print engine 45. For example, in the case of a character type pixel, the selector 46 selects the output signal of the fine line respect screen 42 for the pixel and feeds the selected output signal to the print engine 45 because the screen control information indicates the fine line respect screen 42.

As described above, since the CMM 48 generates a tag plate, high speed processing can be expected compared with a method of generating a tag plate in such a manner that the RIP portion as an interpreter processes a drawing command by replacement.

In the exemplary embodiment described above, the CMM 48 generates a tag plate based on information of the object type (“spot color” or not, “character” or “photograph”, etc.) provided from the RIP portion 36. On the contrary, in the following modification, the CMM generates a tag plate based on a spot color plate generated by the RIP portion 36.

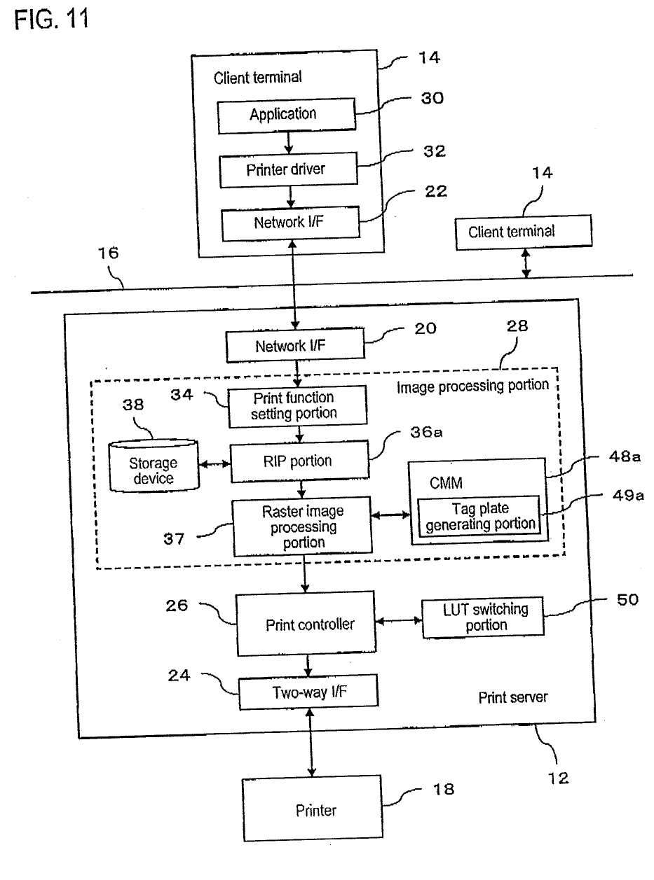

FIG. 11 shows the system configuration of a modification example. In FIG. 11, parts the same as those in FIG. 1 are referred to by the same numerals, and description thereof will be omitted.

In this system, a RIP portion 36a has a function (called plate separating function) of generating a spot color plate other than CMYK plates based on a spot color designation command in a print job written in PDL. When different spot colors are used in a print job, the RIP portion 36a generates spot color plates one by one in accordance with the spot colors. For example, an RIP system having such a plate separating function has been disclosed in JP 2004-14853 5 A (corresponding to US 2004/0080765 A).

A raster image processing portion 37 generates raster images of CMYK plates to be fed to the printer 18, from the raster images of the CMYK plates and respective spot color plates which are provided from the RIP portion 36a. In this processing, a CMM 48a is called for color transformation from the color space of the print job into the color space of the printer 18.

As shown in FIG. 2, a profile for mapping the respective spot colors in the print job onto colors in the CMYK space of the printer 18 is registered in the CMM 48a. The CMM 48a transforms the values of pixels of the spot color plates into CMYK values for the printer 18 using this profile. Incidentally, the reason why the RIP portion 36a generates respective spot color plates once before the raster image processing portion 37 transforms pixel values of the spot color plates into CMYK values for the printer 18 is because the case where, for example, objects of different spot colors may be overprinted is assumed.

The CMM 48a further has a function (tag plate generating portion 49a) of generating a tag plate indicating as to whether or not each pixel is “spot color”, based on the raster image of a spot color plate.

In this example, the raster image processing portion 37 inputs the raster images of the respective plates input from the RIP portion 36a, to the CMM 48a successively.

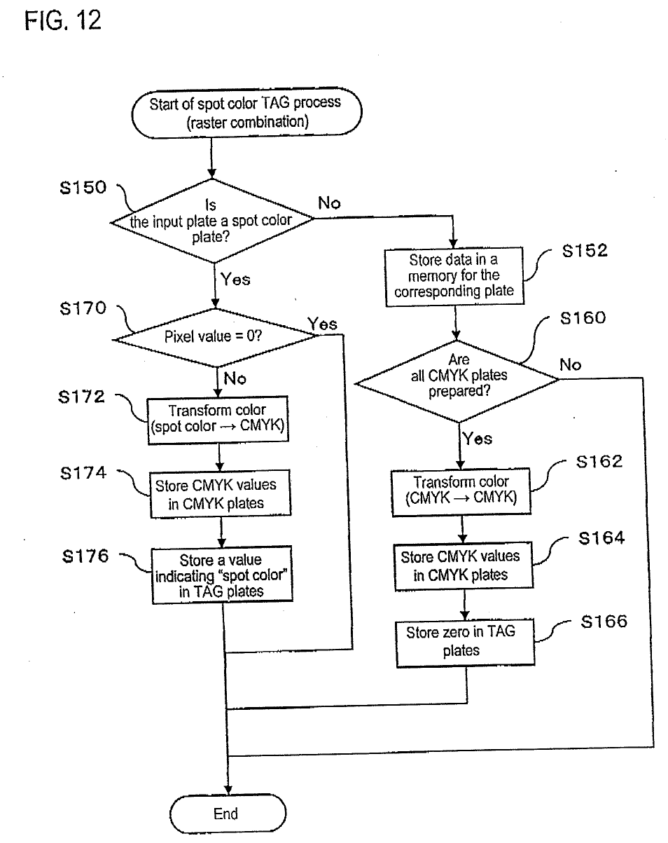

FIG. 12 shows an example of a process procedure executed by the CMM 48a. This procedure is executed whenever the raster image processing portion 37 inputs the raster image of one plate to the CMM 48a.

In this procedure, the CMM 48a first determines as to whether or not the raster image input from the raster image processing portion 37 is of a spot color plate (S150).

When the determination results in that the input raster image is not of a spot color plate, that is, the input raster image is of any of CMYK plates, the CMM 48a stores the raster image in a memory area reserved for a corresponding one of the CMYK plates (S152). Then, the CMM 48a determines as to whether or not all the raster images of the CMYK plates are complete on the memory (S160). When all the raster images of the CMYK plates are not complete, the process is terminated, and the CMM 48a waits for inputting of a next plate.

When the determination in the step S160 results in that all the raster images of the CMYK plates are complete on the memory, the CMM 48a transforms a set of values in the CMYK plates into a set of values in the CMYK plates in the color space of the printer 18 in accordance with respective pixels of an image (S162) and stores results of the transformation in the output CMYK plates reserved on the memory (S164). The CMM 48a further writes “0” into the respective pixels of the tag plate (S166).

On the other hand, when the determination in the step S150 results that the input plate is a spot color plate, the CMM 48a determines in accordance with respective pixels of the plate, as to whether or not the pixel value is “0” (S170). When the pixel value is “0”, the process is terminated without any process on the pixel. When the determination in the step S170 results that the pixel value of the spot color plate is not “0”, the CMM 48a transforms the pixel value into color values in the CMYK space of the printer 18 (S172), writes results of the transformation into corresponding pixels in the output CMYK plates (S174), and writes a value indicating “spot color” in a corresponding pixel of the tag plate (S176).

In such a sequence that the spot color plate is input after the CMYK plates, the tag plate indicating spot color objects can be generated by the aforementioned process. When there are plural spot color plates, the procedure of the steps S170 to S176 can be repeated in accordance with the spot color plates.

The tag plate thus generated can be used in the same manner as in the aforementioned exemplary embodiment.

Also in this modification example, the tag plate indicates the type of each image object as to whether or not the image object is a spot color object.

Although the modification example has been described on the case where the RIP portion 36a generates each spot color plate by plate separation, the tag plate can be generated in the same manner in the case where a set of CMYK and spot color plates generated by an external apparatus are input to the print server 12.

The exemplary embodiments and modification examples have been described above. Each of pixels in the raster image of the tag plate generated by the exemplary embodiments and modification examples has a value indicating the type of an image object to which the pixel belongs. Although whether it is a spot color object or not, whether it is a K100 object or not, and whether it is a character object or a photograph object, are exemplified as the type of the image object, the type of the image object is not limited thereto. For example, the type of the image object can be determined based on a command affecting a plurality of image objects, such as a command for instructing drawing of individual image objects (e.g. “show”, “image”, etc.) or a command for designating a color space (e.g. “setcolorspace”) or a color (e.g. “setcolor”), or a combination of these kinds of commands.

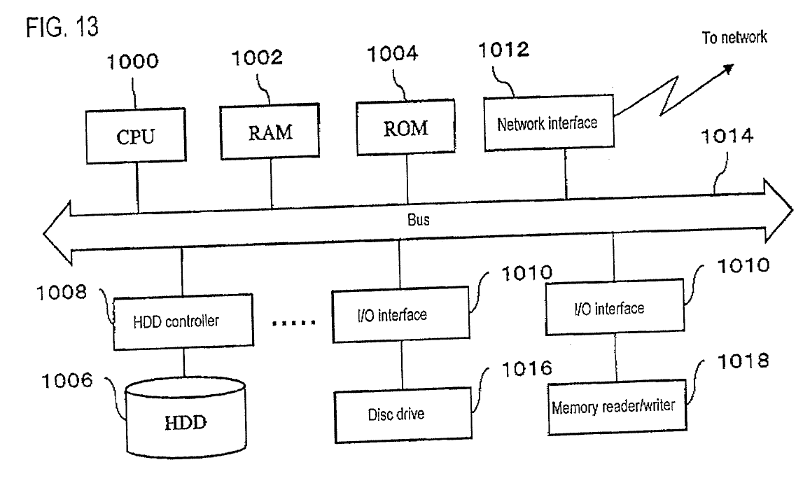

For example, the image processing portion 28 in the exemplary embodiment and modification as described above can be achieved by a program expressing processing in the aforementioned functional modules and a genera-purpose computer for executing the program. For example, as shown in FIG. 13, the computer has a circuit configuration as hardware in which a microprocessor such as a CPU 1000, memories (primary storages) such as a random access memory (RAM) 1002 and a read only memory (ROM) 1004, an HDD controller 1008 for controlling an HDD (hard disk drive) 1006, various I/O (input/output) interfaces 1010, a network interface 1012 for performing control for connection to a network such as a local area network, and so on, are connected to one another, for example, through a bus 1014. A disk drive 1016 for performing reading and/or writing on a portable disk recording medium such as a CD or a DVD, a memory reader/writer 1018 for performing reading and/or writing on portable nonvolatile recording media of various standards such as a flash memory, and so on, may be connected to the bus 1014, for example, via the I/O interfaces 1010. The program in which processing contents of the functional modules as described above are written is stored in a stationary storage device such as a hard disk drive via a recording medium such as a CD or a DVD or via communication means such as a network and installed in the computer. The program stored in the stationary storage device is read into the RAM 1002 and executed by the microprocessor such as the CPU 1000 to thereby achieve the aforementioned set of functional modules. Incidentally, part or all of the set of functional modules may be configured as a hardware circuit such as a special purpose LSI (Large Scale Integration), an ASIC (Application Specific Integrated Circuit) or an FPGA (Field Programmable Gate Array).

What is claimed is:

1. An image processing apparatus comprising:
a color transformation unit that color-transforms pixel values of respective pixels expressed by input image information from values in a color space of the input image information into values in a color space of a printer to generate images of respective color plates in the color space of the printer, the color transformation unit that generates a control image in which each pixel has a pixel value indicating a type of an image object to which each pixel belongs; and
an image processing unit that applies image processing to each pixel in the image of each color plate in accordance with the type of the image object indicated by the pixel value of a pixel, corresponding to each pixel in the image of each color plate, of the control image and feeds the processed images of the respective color plates to the printer.

2. The image processing apparatus according to claim 1, wherein
the input image information contains commands for drawing the image objects, and
the color transformation unit determines the type of the image object corresponding to each command based on each command, and writes a pixel value corresponding to the determined type into respective pixels, which belong to the image object corresponding to each command, of the control image.

3. The image processing apparatus according to claim 2, wherein
the color transformation unit writes a pixel value indicating a spot color image object into respective pixels, which are determined based on each command to belong to the spot color image object, of the control image,
the image processing unit includes
a color reproduction characteristic storage unit that stores color reproduction characteristic information, and
a correction unit that corrects pixel values in the images of the respective color plates input from the color transformation unit in accordance with the color reproduction characteristic information stored in the color reproduction characteristic storage unit, the correction unit that does not correct the pixel value of the respective pixels, which are determined based on the control image to belong to the spot color image object, in accordance with the color reproduction characteristic information.

4. The image processing apparatus according to claim 1, wherein
the input image information contains
the images of the respective color plates in the color space of the input image information, and
an image of a spot color plate different from the respective color plates in the color space, and
the color transformation unit writes a pixel value indicating a spot color image object into pixels, which are determined based on the image of the spot color plate to belong to spot color pixels, of the control image, and writes a pixel value indicating an ordinary image object into pixels, which are determined not belong to the spot color pixels, of the control image.

5. An image processing method comprising:
color-transforming pixel values of respective pixels expressed by input image information from values in a color space of the input image information into values in a color space of a printer to generate images of respective color plates in the color space of the printer;
generating a control image in which each pixel has a pixel value indicating a type of an image object to which each pixel belongs; and
applying image processing to each pixel in the image of each color plate in accordance with the type of the image object indicated by the pixel value of a pixel, corresponding to each pixel in the image of each color plate, of the control image and feeds the processed images of the respective color plates to the printer.

6. A computer-readable medium storing a program causing a computer to execute image processing, the image processing comprising:
color-transforming pixel values of respective pixels expressed by input image information from values in a color space of the input image information into values in a color space of a printer to generate images of respective color plates in the color space of the printer;
generating a control image in which each pixel has a pixel value indicating a type of an image object to which each pixel belongs; and
applying image processing to each pixel in the image of each color plate in accordance with the type of the image object indicated by the pixel value of a pixel, corresponding to each pixel in the image of each color plate, of the control image and feeds the processed images of the respective color plates to the printer.
